(19) United States
(12) Patent Application Publication
(10) Pub. No.: US 2024/0249084 A1
(43) Pub. Date: Jul. 25, 2024

(54) SERVERS, SYSTEMS AND METHODS FOR MACHINE TRANSLATION AS A COMPUTERIZED AND/OR NETWORK-PROVIDED SERVICE

(71) Applicant: Aveva Software, LLC, Lake Forest, CA (US)

(72) Inventors: Aarthy Thasma Ravindran, Lake Forest, CA (US); William Chan, Oakville (CA); Jian He, San Francisco, CA (US); Forrest Scott, Beamsville (CA)

(21) Appl. No.: 18/423,094

(22) Filed: Jan. 25, 2024

Related U.S. Application Data
(60) Provisional application No. 63/441,082, filed on Jan. 25, 2023.

(51) Int. Cl. G06F 40/51

(52) U.S. Cl. CPC G06F 40/51

(57) ABSTRACT

Disclosed are systems and methods for a novel machine translation as a service (MTaS) framework that enables real-time machine translation to realize improved accuracy without degrading the speed in which a translator can operate. The disclosed translator technology can provide an improved, computationally efficient and accurate system that can improve how translations are provided, which can improve how translation-based processes are performed. The disclosed framework enables translation string gaps between translated releases to be identified, filled and/or corrected. Such automated and/or selected translation correction, modification and/or fine-tuning can be enabled via any type of translation model and/or model combination. The disclosed framework effectively enables a crowd-sourced translation to be performed, which can include, but is not limited to, translations from a plurality of translator models, repetitive translations via a translation model and/or translations that account for user feedback from particular translation releases, and the like, or some combination thereof.

### REFERENCE TO RELATED APPLICATION

This application claims the benefit of priority from U.S. Provisional Application No. 63/441,082, filed Jan. 25, 2023, entitled “SERVERS, SYSTEMS AND METHODS FOR MACHINE TRANSLATION AS A COMPUTERIZED AND/OR NETWORK-PROVIDED SERVICE,” which is incorporated herein by reference in its entirety.

### FIELD OF THE DISCLOSURE

The present disclosure is generally related to machine translation, and more particularly, to an machine translation as a service (MTaS) to that provides end-to-end (E2E) translation functionality between translatable releases and crowd-sourced translation models.

### BACKGROUND

The present disclosure is generally related to machine translation, and more particularly, to an machine translation as a service (MTaS) to that provides end-to-end (E2E) translation functionality between translatable releases and crowd-sourced translation models.

### SUMMARY OF THE DISCLOSURE

Current machine translation utilizes machine learning and/or artificial intelligence (ML/AI) algorithms, models and/or techniques, and goes beyond simple word-to-word (W2W) translation to communicate the full meaning of the original language text in the target language.

Modern machine translation techniques can involve statistical machine translation (SMT), rule-based machine translation (RBMT), hybrid machine translation (HMT) and neural machine translation (NMT), as discussed below.

As provided herein, the disclosed systems, servers and methods provide a novel MTaS framework (or platform) that enables real-time machine translation to realize improved accuracy without degrading the speed in which a translator can operate. Thus, the disclosed translator technology can provide an improved, computationally efficient and accurate system that can improve how translations are provided, which can improve how translation-based processes are performed.

According to some embodiments, the disclosed framework enables translation string gaps between translated releases to be identified, filled and/or corrected. Such automated and/or selected translation correction, modification and/or fine-tuning can be enabled via any type of translation model. For example, if a translation on a text string commences via a SMT, during the processing and/or at the conclusion of an iterative release of the SMT translation, a second SMT and/or other type of translator (e.g., RBMT, HMT and/or NMT) can be applied to improve the initial releases accuracy. For example, the a text string, which is initially formatted and/or constitutes a first language, is translated by SMT, and then upon detecting inaccuracies in the translation by the SMT, a NMT can be applied.

Thus, according to some embodiments, a hybrid, advanced-step, translation service can be provided. Rather than simply relying on a single, iteratively applied translator, the disclosed systems and methods provided novel mechanisms for translation string gaps to be filled between and/or during translation releases via innovatively applied translation models, as discussed herein. Indeed, according to some embodiments, corrections, gap-fills and/or modifications to translation releases can be leveraged to improve the operational efficiency and accuracy of applied translation models, in that the information used to perform such corrections and/or the corrections themselves, inter alia, can be recursively fed back to the disclosed translations models to improve the speed in which such accurate outputs are provided.

As such, according to some embodiments, the disclosed framework effectively enables a crowd-sourced translation to be performed, which can include, but is not limited to, translations from a plurality of translator models, repetitive translations via a translation model and/or translations that account for user feedback from particular translation releases, and the like, or some combination thereof. According to some embodiments, as discussed below, the MTaS can be provided via a cloud service and/or software as a service (SaaS) product (such as, for example, via an application program hosted and provided via AVEVA Connect®). Indeed, as discussed below, the disclosed MTaS can be provided via any type of local, network and/or hybrid-type service product.

According to some embodiments, a method is disclosed for a novel machine translation service that provides E2E translation functionality between translatable releases and crowd-sourced translation models. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a machine translation service that provides E2E translation functionality between translatable releases and crowd-sourced translation models.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

In some embodiments, the disclosure is directed to a method comprising one or more steps, where the method steps may also represent program instructions stored on one or more non-transitory computer readable media that cause one or more computers comprising one or more processors and the one or more non-transitory media to implement the method steps in accordance with a system. Some embodiments include a step of receiving, by a device, a request to translate a character string. In some embodiments, the character string comprises text. Some embodiments include a step of analyzing, by the device, which may include the afore mentioned one or more computers, the character string, and determining, based on the analysis, language information associated with the text. Some embodiments include a step of identifying, by the device, based on the language information, a translator model. Some embodiments include a step of performing, by the device, a machine translation of the character string by executing the translator model with the character string as input. Some embodiments include a step of identifying, by the device, a translation release, the translation release comprising at least a portion of the text being translated from an original language to a target language. Some embodiments include a step of determining, by the device, an accuracy of the translation release. Some embodiments include a step of outputting, by the device, for display within a user interface (UI), the translation release based on the determined accuracy.

In some embodiments, the output of the translation release comprises functionality for feedback to be provided to at least a portion of the translated text. In some embodiments, the functionality is provided based on the determined accuracy. Some embodiments include a step of receiving the feedback. In some embodiments, the system is configured to use the feedback as a basis for continued machine translation of the character string. In some embodiments, the continued machine translation comprises at least one of modification of the translation release and re-translation of the character string. Some embodiments include a step of identifying another translator model. Some embodiments include a step of performing another machine translation based on the other translator model.

In some embodiments, the system is configured to provide the feedback, by the device, based on autonomous analysis of the translation release. In some embodiments, the feedback comprises user input corresponding at least a portion of the translation release. In some embodiments, the language information comprises information selected from a group consisting of: a type of language, format of language, source of language, grammar, language pairs, syntax, phrases, punctuation, paragraphs, wild-cards, format of the text and/or character string, relationship to a target language and identity of a dictionary defining terms of the language.

In some embodiments, the translation release is identified during the performance of the machine translation. In some embodiments, the translation release is an output of the translator model at a conclusion of an iteration of the execution of the translation model.

### DESCRIPTION OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

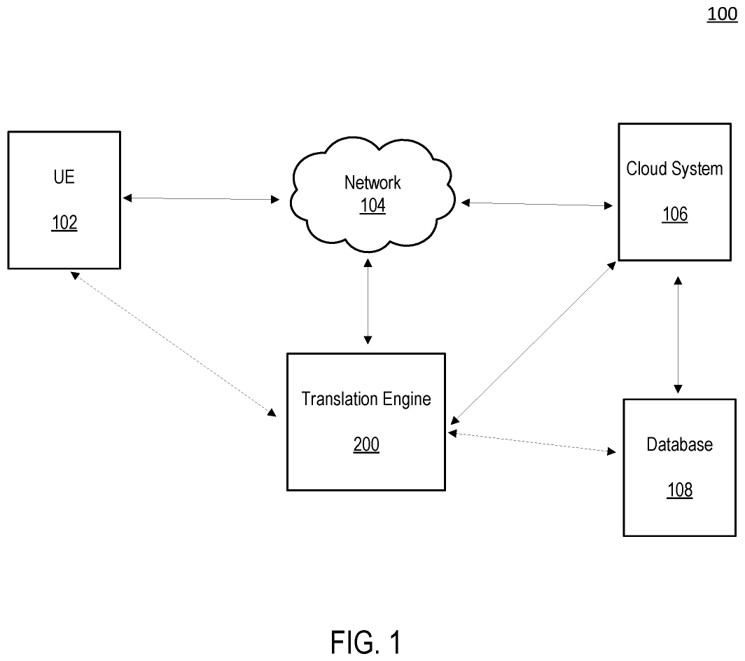

Certain embodiments and principles will be discussed in more detail with reference to the figures. With reference to FIG. 1, system 100 is depicted which provides an example embodiment according to components for providing machine translation service that provides E2E translation functionality between translatable releases and crowd-sourced translation models, as discussed herein.

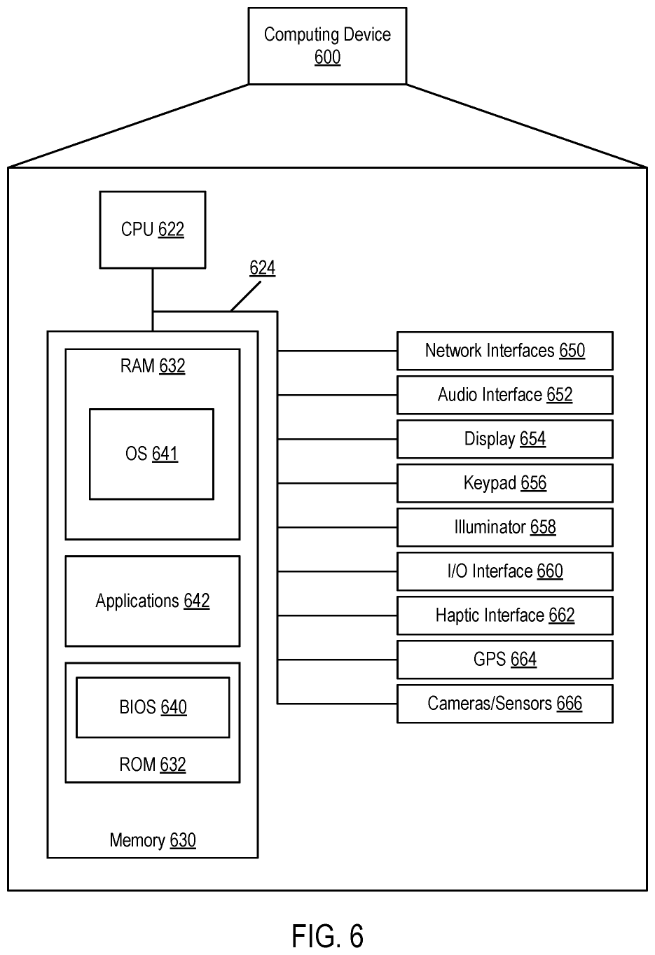

According to some embodiments, system 100 includes UE 102 (e.g., a client device, as mentioned above and discussed below in relation to FIG. 6), network 104, cloud system 106, database 108, translation engine 200. It should be understood that while system 100 is depicted as including such components, it should not be construed as limiting, as one of ordinary skill in the art would readily understand that varying numbers of UEs, peripheral devices to UEs (not shown), cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, autonomous machine, and any other device equipped with a cellular or wireless or wired transceiver. In some embodiments, UE 102 can be a device associated with an individual (or set of individuals) for which access local and/or network-hosted translation services are provided.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture, which has associated network resources hosted on the internet or private network (e.g., network 104), which enables (via engine 200) the novel translation services, as discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 102, UE 102, and the services and applications provided by cloud system 106 and/or translation engine 200.

In some embodiments, for example, cloud system 106 can provide a private/proprietary industrial software platform (e.g., AVEVA®), whereby engine 200, discussed infra, corresponds to the novel functionality system 106 enables, hosts and provides to a network 104 and other devices/platforms operating thereon.

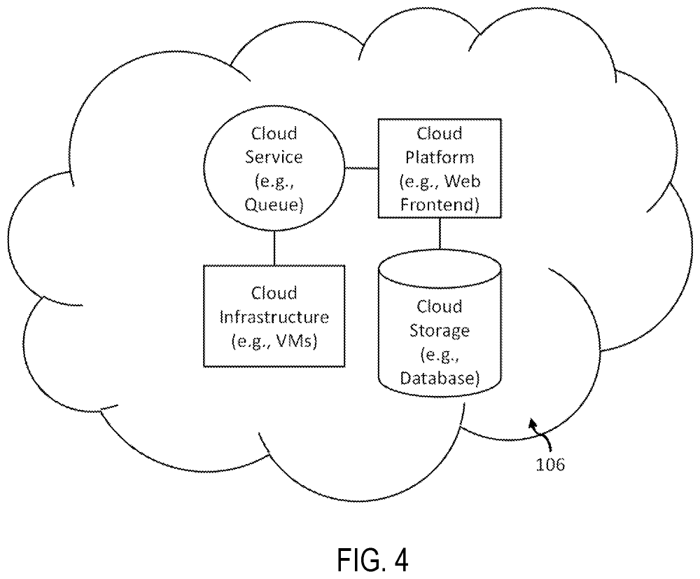

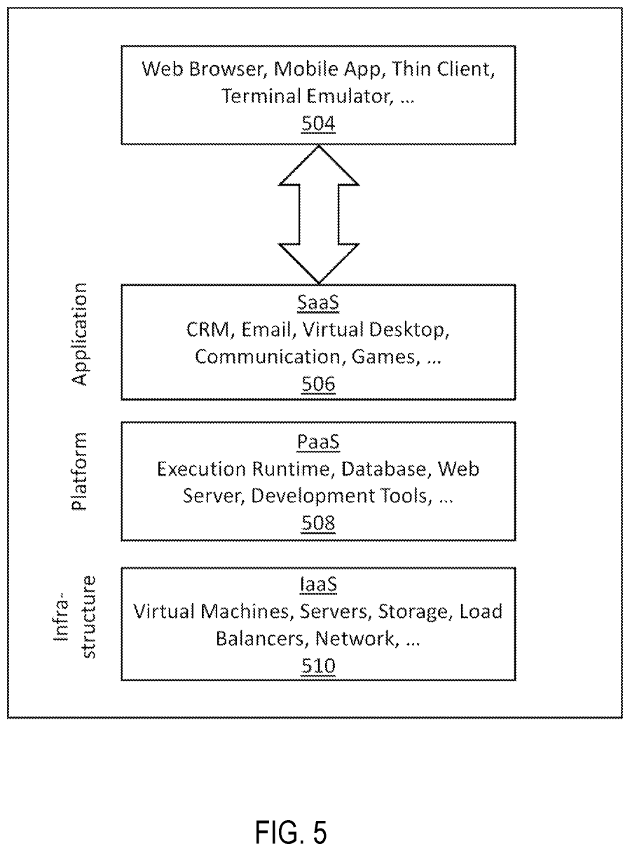

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 510, platform as a service (PaaS) 508, and/or software as a service (SaaS) 506 using a web browser, mobile app, thin client, terminal emulator or other endpoint, network location, application program interface (API) or device, and the like. FIGS. 4 and 5 illustrate schematics of non-limiting implementations of the cloud computing/architecture(s) in which the exemplary computer-based systems for administrative customizations and control of network-hosted APIs of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL).

According to some embodiments, database 108 may correspond to a distributed ledger of a distributed network. In some embodiments, the distributed network may include a plurality of distributed network nodes, where each distributed network node includes and/or corresponds to a computing device associated with at least one entity (e.g., the entity associated with cloud system 106, for example, discussed supra). In some embodiments, each distributed network node may include at least one distributed network data store configured to store distributed network-based data objects for the at least one entity. For example, database 108 may correspond to a blockchain (e.g., a distributed ledger), where the distributed network-based data objects can include, but are not limited to, account information, medical information, entity identifying information, wallet information, device information, network information, credentials, security information, permissions, identifiers, smart contracts, transaction history, and the like, or any other type of known or to be known data/metadata related to an entity's and/or user's information, structure, business and/or legal demographics, inter alia.

Translation engine 200, as discussed above and further below in more detail, can include components for the disclosed functionality. According to some embodiments, translation engine 200 may be a special purpose machine or processor and can be hosted by a device on network 104, within cloud system 106 and/or on UE 102. In some embodiments, engine 200 may be hosted by a server and/or set of servers associated with cloud system 106.

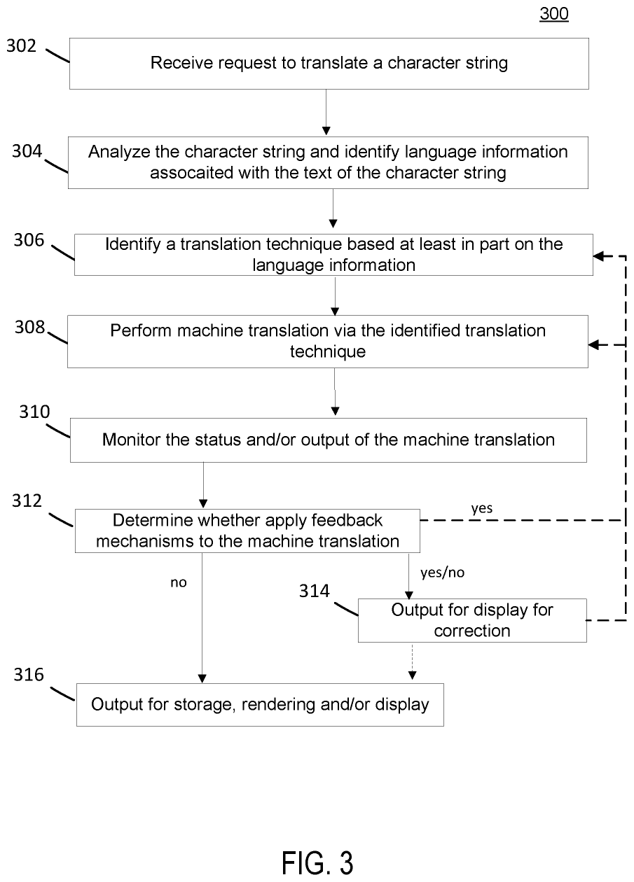

According to some embodiments, as discussed in more detail below, translation engine 200 may be configured to implement and/or control a plurality of services and/or microservices, where each of the plurality of services/microservices are configured to execute a plurality of workflows associated with performing the disclosed functionality. Non-limiting embodiments of such workflows are provided below in relation to at least FIG. 3, inter alia.

According to some embodiments, as discussed above, translation engine 200 may function as an application provided by cloud system 106. In some embodiments, engine 200 may function as an application installed on a server(s), network location and/or other type of network resource associated with system 106. In some embodiments, engine 200 may function as application installed and/or executing on UE 102. In some embodiments, such application may be a web-based application accessed by UE 102 and/or devices over network 104 from cloud system 106. In some embodiments, engine 200 may be configured and/or installed as an augmenting script, program or application (e.g., a plug-in or extension) to another application or program provided by cloud system 106 and/or executing on UE 102.

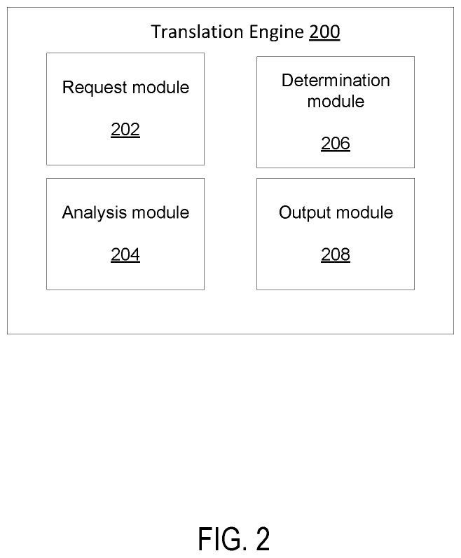

As illustrated in FIG. 2, according to some embodiments, translation engine 200 includes request module 202, analysis module 204, determination module 206, output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments for a MTaS framework (e.g., via translation engine 200, as provided herein) that enables translation string gaps between translated releases to be identified, filled and/or corrected, whereby such automated and/or selected translation correction, modification and/or fine-tuning can be enabled via any type of translation model and/or model combination. Thus, as discussed herein, according to some embodiments, the disclosed framework effectively enables a crowd-sourced translation to be performed, which can include, but is not limited to, translations from a plurality of translator models, repetitive translations via a translation model and/or translations that account for user feedback from particular translation releases, and the like, or some combination thereof.

According to some embodiments, Step 302 of Process 300 can be performed via request module 202 of translation engine 200; Steps 304 and 310 can be performed by analysis module 204; Steps 306, 308 and 312 can be performed by determination module 206; and Steps 314 and 316 can be performed by output module.

According to some embodiments, Process 300 begins with Step 302 where engine 200 receives a request to translate a character string. In some embodiments, the request can be received from, but not limited to, a user, content or provider, network resource (e.g., a server or other device associated with an application, API and/or network location, and the like), an API, application, and the like, or some combination thereof. For example, a request can be generated by a user requesting the translation of text from an initial language to a target language. In another non-limiting example, the request can correspond to a request to load an electronic document (e.g., web page), whereby a translation of the document's (e.g., the text of the document) initial format/language to a target language/format that correlates to capabilities of the device and/or application being used to render the document is required. Thus, in some embodiments, for example, the request can correspond to a request to translate text displayed within/on a page displayed by a user interface (UI).

In some embodiments, the character string can be included in the request, or referenced via a pointer to another remote or local location where the text is stored (e.g., via a uniform resource locator (URL)). In some embodiments, the character string can include any type of text, inclusive of alpha-numeric and/or letters or numbers. In some embodiments, the character string can be of any length or size, or can correspond to a predetermined length/size. For example, the character string can be filtered or trimmed to correspond to a criteria for a specific type of translation.

In some embodiments, the character string can be provided by a user (e.g., typed or a by-product of a voice input, and/or any other type of input), and the like. For example, the character string can correspond to an image, whereby data/metadata relating to the image can be formulated from analysis and extraction of data/metadata describing the image.

According, in some embodiments, the request can include information related to, but not limited to, a user identifier (ID), entered/input text, text from a network page, source code, text in a message, document specifications, asset specifications and/or output, a target language, target format, target length/size, and the like, or some combination thereof. For example, the request can include character strings for the operational values and/or statuses of an asset, and the asset's output related to the asset's performance at a jobsite.

In Step 304, engine 200 can analyze the character string, and identify the language information associated with the text of the character string included therein. That is, in some embodiments, the character string (and/or other information related to the character string, including data and/or metadata related to the character string, source of the character string, included text, requesting user, and the like, as discussed above) can be analyzed, whereby data can be determined, derived, detected or otherwise identified that relates to language information of the text of the character string. In some embodiments, the language information can include, but is not limited to, the type of language of the text, format of the language of the text, source of the language, grammar, language pairs, syntax, phrases, punctuation, paragraphs, wild-cards (e.g., unknown text or spaces, for example, when compared to a known dictionary), format of the text/character string, relationship to a target language, identity of a dictionary defining terms of the language, and the like, or some combination thereof. Accordingly, the language information identified in Step 304 can correspond to an original, source or initial language information (for which translation is to occur, as discussed infra).

According to some embodiments, Step 304 can include engine 200 parsing the request, and extracting, determining or otherwise identifying the character string form the information included in the request. Accordingly, in some embodiments, Step 304 can scrape, parse and/or utilize a data mining technique to identify and extract the character string from the text.

In some embodiments, information related to the analysis and determination/identification of Step 304 can be stored in database 108, as discussed above, which can additionally be used for further training of the models (e.g., ML/AI applied/executed by engine 200).

In some embodiments, the analysis and determination of Step 304 can be performed via engine 200 executing and/or implementing any type of known or to be known computational analysis technique, algorithm, mechanism or technology, which can include, but is not limited to, a specific trained ML/AI, a particular machine learning model architecture, a particular machine learning model type (e.g., convolutional neural network (CNN), recurrent neural network (RNN), autoencoder, support vector machine (SVM), etc.), or any other suitable definition of a machine learning model or any suitable combination thereof.

In some embodiments, engine 200 can utilize any type of known or to be known ML/AI natural language processing algorithm, including, but not limited to, topic modelling, keyword extraction, lemmatization and stemming, knowledge graphs, word clouds, sentiment analysis, entity recognition, text summarization, bag of words, tokenization, and the like, or some combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of neural network may be executed as follows:
a. define neural network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 306, engine 200 can identify a translation technique (or model) to apply to the character string identified in the request of Step 302.

According to some embodiments, a non-limiting set of translation models can be identified, and analyzed, which can be based on the language information identified in Step 304, whereby an appropriate type of translation model(s) can be determined. In some embodiments, the type of translation model(s) identified/selected can be based on which model most adeptly can translate the text as provided for via the language information. For example, which translation model works best for the syntax, language pairs, language type, origin language, industry type, and the like.

In some embodiments, translation models, mentioned above, can involve, but are not limited to, SMT, RBMT, HMT and NMT. Accordingly, any type of known or to be known specific types of SMT, RBMT, HMT and NMT models can be utilized, as one of skill in the art would recognize from the disclosure herein, without departing from the scope of the instant application.

In some embodiments, a SMT model can generate translations based on statistical models whose parameters are derived from bilingual text analysis. A SMT model can be used to identify the relationships between words, phrases, and sentences in the source and target texts.

In some embodiments, a RBMT model relies on grammatical rules to perform a translation. In some embodiments, in order to generate a translated sentence, a RBMT model can perform a grammatical analysis of the source and target languages.

In some embodiments, a HMT is a combination of SMT and RBMT models.

In some embodiments, a NMT model is utilizes AI and neural network analysis to learn languages and improve its accuracy and efficiency (e.g., similar to the neural network discussion above). Effectively, a NMT model can operate as a machine translation engine that uses neural language processing, which can be trained to decipher texts in both the source and target languages.

Accordingly, in some embodiments, engine 200 can leverage the language information from Step 304 and determine which translation model to utilize. For example, for a complex translation (e.g., translation of a UI depicting text related to an asset's performance, errors and output), engine 200 may select a NMT model (and/or a HMT model). For example, if the language information indicates a set of language pairs (e.g., a number of language pairs at or above a threshold amount of language pairs, for example), engine 200 can select a Transformer NMT model.

In some embodiments, engine 200 may apply a standard translation model (e.g., a NMT model), without performing the processing of Step 306, thereby bypassing the processing discussed therein.

In some embodiments, the type of model selected for the language information (or type and/or category of language information), can be stored in database 108, in a similar manner as discussed above.

In Step 308, engine 200 can execute the selected model to perform the requested translation of the character string (e.g., machine translate the text from the original language to the target language, for example). Thus, in some embodiments, engine 200 can compile the character string as input to the selected model, for example, the NMT model, for such machine translation.

In Step 310, engine 200 monitors the status and/or output of the applied translator (e.g., a translated or translation release). In some embodiments, such monitoring can be performed according to a criterion, which can correspond to, but is not limited to, number of characters (or words, sections, paragraphs, sentences, and the like, for example) analyzed, a time period, per a translation release, and the like, or some combination thereof. For example, the monitoring can occur in real-time, such that as the translator model is analyzing the text of the character sting, engine 200 can perform Step 312's determination, as discussed infra. For example, if the character string includes three (3) paragraphs, at the conclusion of each paragraphs translation, this can be considered a translation/translated release, whereby engine 200 can proceed to Step 312. In some embodiments, in another example, at the conclusion of a first complete translation, this can be considered a translation/translated release, whereby engine 200 can proceed to step 312.

In some embodiments, engine 200 can enable a user to toggle the applied translator model (or machine translator) to ON or OFF. This can enable a real-time analysis of the on-going translation to ensure its accuracy (and avoid inaccurate translations of already translated text and to-be translated text), as discussed infra.

In Step 312, engine 200 can perform a determination as to whether to apply and/or enable feedback mechanisms to the release of the translator model. That is, whether the machine translation performed by the applied translation model requires corrections, fill-ins, modifications, and the like.

In some embodiments, Step 312 can involve a user requesting a pause in the translation, thereby turning the machine translator/translation model temporarily OFF, as discussed above. Thus, in Step 314, a current output of the translation can be output to a UI for viewing by a user.

In some embodiments, in Step 314, the user can annotate and/or provide input to, but not limited to, correct text, modify text, fill-in text, verify text, identify or highlight text for re-analysis, and the like, or some combination thereof. Upon receiving the user's provided feedback, the information can be stored in database 108, processing can recursively proceed back to either Step 306 and/or Step 308. That, is, in some embodiments, engine 200 can perform another selection of a translation model (as in Step 306), which can further be based on the provided feedback, or engine 200 can proceed to Step 308, where the previously applied translation model can be re-applied.

In some embodiments, the continued translation can commence from, but not limited to, where it left off (e.g., when the translator model was toggled to OFF), at location within the text identified by a user (e.g., which text was highlighted or demarked/tagged by an annotation), at the beginning of the text (e.g., restart the translation), and the like, or some combination thereof.

In some embodiments, in Step 314, if the user(s) does not have nor does the user provide feedback, then processing can proceed to Step 316.

In some embodiments, Step 312 can involve engine 200 pausing the on-going translation (e.g., according to the monitoring of Step 310, as discussed above) or analyzing a completed release of the translator model, and analyzing the respective translator release to determine if feedback, corrections and/or re-processing is required. According to some embodiments, such analysis and determination can be performed via any of the ML/AI algorithms discussed above in relation to Step 304.

In some embodiments, when engine 200 automatically determines that feedback (e.g., modifications, fill-ins and/or corrections, for example) are required, engine 200 can recursively proceed back to Step 306 or Step 308. In some embodiments, engine 200 can autonomously annotate the translation release and provided for further processing, in a similar manner as discussed above. Such recursive processing can be performed in a similar manner as discussed above.

In some embodiments, when engine 200 automatically determines that no feedback is required, processing can proceed to Step 314, which can be performed in a similar manner as discussed above.

In some embodiments, when engine 200 (and/or a user) determine that no feedback is required, processing can proceed to Step 316. In Step 316, the translated character string can be stored in database 108, and used to further train the ML/AI algorithms and/or translator models utilized by engine 200, as discussed above. In Step 316, engine 200 can output the translated character string for display within a UI, and/or as input to a rendering application or device.

Thus, according to some embodiments, Process 300 enables the automatic machine translation of character strings between and/or during translated releases, thereby providing and E2E translated product, as provided for in the disclosure herein.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; ×86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a device, a request to translate a character string, the character string comprising text;
analyzing, by the device, the character string, and determining, based on the analysis, language information associated with the text;
identifying, by the device, based on the language information, a translator model;
performing, by the device, a machine translation of the character string by executing the translator model with the character string as input;
identifying, by the device, a translation release, the translation release comprising at least a portion of the text being translated from an original language to a target language;
determining, by the device, an accuracy of the translation release; and
outputting, by the device, for display within a user interface (UI), the translation release based on the determined accuracy.

2. The method of claim 1,
wherein the output of the translation release comprises functionality for feedback to be provided to at least a portion of the translated text, wherein the functionality is provided based on the determined accuracy.

3. The method of claim 2, further comprising:
receiving the feedback, wherein the feedback is used as a basis for continued machine translation of the character string.

4. The method of claim 3,
wherein the continued machine translation comprises at least one of modification of the translation release and re-translation of the character string.

5. The method of claim 3, further comprising:
identifying another translator model; and
performing another machine translation based on the other translator model.

6. The method of claim 2,
wherein the feedback is provided by the device based on autonomous analysis of the translation release.

7. The method of claim 2,
wherein the feedback comprises user input corresponding at least a portion of the translation release.

8. The method of claim 1,
wherein the language information comprises information selected from a group consisting of:
a type of language, format of language, source of language, grammar, language pairs, syntax, phrases, punctuation, paragraphs, wild-cards, format of the text and/or character string, relationship to a target language and identity of a dictionary defining terms of the language.

9. The method of claim 1,
wherein the translation release is identified during the performance of the machine translation.

10. The method of claim 1,
wherein the translation release is an output of the translator model at a conclusion of an iteration of the execution of the translation model.

11. A system comprising:
one or more processors and one or more non-transitory computer readable media, the one or more non-transitory computer readable media comprising program instructions stored thereon that when executed cause the one or more computers to:
receive, by the one or more processors, a request to translate a character string, the character string comprising text;
analyze, by the one or more processors, the character string;
determine, based on the analysis, language information associated with the text;
identify, based on the language information, a translator model;
perform, by the one or more processors, a machine translation of the character string by executing the translator model with the character string as input;
identify, by the one or more processors, a translation release, the translation release comprising at least a portion of the text being translated from an original language to a target language;
determine, by the one or more processors, an accuracy of the translation release; and
output, by the one or more processors, for display within a user interface (UI), the translation release based on the determined accuracy;
wherein the output of the translation release comprises functionality for feedback to be provided to at least a portion of the translated text; and
wherein the functionality is provided based on the determined accuracy.

12. The system of claim 11,
wherein the system is configured to use the feedback as a basis for continued machine translation of the character string; and
wherein the continued machine translation comprises at least one of modification of the translation release and re-translation of the character string.

13. The system of claim 11,
wherein the one or more non-transitory computer readable media further comprise program instructions stored thereon that when executed cause the one or more computers to:
receive, by the one or more processors, the feedback;
wherein the system is configured to use the feedback as a basis for continued machine translation of the character string; and
wherein the continued machine translation comprises at least one of modification of the translation release and re-translation of the character string.

14. The system of claim 11,
wherein the one or more non-transitory computer readable media further comprise program instructions stored thereon that when executed cause the one or more computers to:
identify, by the one or more processors, another translator model; and
perform, by the one or more processors, another machine translation based on the other translator model.

15. The system of claim 11,
wherein the feedback comprises user input corresponding at least a portion of the translation release;
wherein the system is configured to identify the translation release during the performance of the machine translation; and
wherein the translation release includes an output of the translator model at a conclusion of an iteration of the execution of the translation model.
